(19) United States
(12) Patent Application Publication
(10) Pub. No.: US 2015/0167131 A1
(43) Pub. Date: Jun. 18, 2015

(54) SURFACE ALLOYED METALS AND METHODS FOR ALLOYING SURFACES

(71) Applicant: Arcanum Alloy Design, Inc., Sunnyvale, CA (US)

(72) Inventors: Daniel E. Bullard, Sunnyvale, CA (US); Joseph E. McDermott, Sunnyvale, CA (US); Adam Thomas, Sunnyvale, CA (US)

(21) Appl. No.: 14/565,216

(22) Filed: Dec. 9, 2014

Related U.S. Application Data
(60) Provisional application No. 61/914,794, filed on Dec. 11, 2013.

(51) Int. Cl. C22C 38/18; B23K 20/02; C22C 38/00

(52) U.S. Cl. CPC C22C 38/18; C22C 38/00; B23K 20/02

(57) ABSTRACT

The disclosure provides a material that includes a stainless steel layer with a consistent composition diffusion bonded to a carbon steel substrate. The material can have the corrosion resistance associated with the explosively welded stainless steel and the deep diffusion bonding observed typical of chromizing applications.

### CROSS-REFERENCE

This application claims priority to U.S. Provisional Patent Application No. 61/914,794 filed Dec. 11, 2013, said application is incorporated herein by reference in its entirety for all purposes.

### BACKGROUND

Steel can be an alloy of iron and other elements, including carbon. When carbon is the primary alloying element, its content in the steel may be between 0.002% and 2.1% by weight. Without limitation, the following elements can be present in steel: carbon, manganese, phosphorus, sulfur, silicon, and traces of oxygen, nitrogen and aluminum. Alloying elements added to modify the characteristics of steel can include without limitation: manganese, nickel, chromium, molybdenum, boron, titanium, vanadium and niobium.

Stainless steel can be a material that does not readily corrode, rust (or oxidize) or stain with water. There can be different grades and surface finishes of stainless steel to suit a given environment. Stainless steel can be used where both the properties of steel and resistance to corrosion are beneficial.

### SUMMARY

In an aspect, the disclosure provides a protective coating for steel. In some cases, a non-stainless steel product is metallurgically bonded to and carrying a stainless steel outer layer.

In another aspect, the disclosure provides a material that comprises an alloyed metal layer having an alloying agent, the alloyed metal layer being coupled to a substrate with the aid of a diffusion layer between the alloyed metal layer and the substrate, where the amount of alloying agent in the diffusion layer changes with depth at a rate between about −0.01% per micrometer and −5.0% per micrometer as measured by x-ray photoelectron spectroscopy.

In some embodiments, the amount of alloying agent in the diffusion layer changes with depth at a rate between about −0.05% per micrometer and −1.0% per micrometer as measured by x-ray photoelectron spectroscopy.

In some embodiments, the diffusion layer provides a metallurgical bond between the alloyed metal layer and the substrate.

In some embodiments, the alloyed metal comprises stainless steel.

In some embodiments, the alloying agent comprises chromium.

In some embodiments, the alloying agent comprises nickel.

In some embodiments, the alloying agent comprises iron.

In some embodiments, the substrate comprises a steel substrate.

In some embodiments, the substrate comprises a low-carbon steel.

In some embodiments, the substrate comprises carbon steel.

In some embodiments, the thickness of the alloyed metal layer is less than 200 micrometers.

In some embodiments, the thickness of the alloyed metal layer is less than 100 micrometers.

In some embodiments, the amount of alloying agent in the diffusion layer changes with depth at a rate between about −0.15% per micrometer and −0.60% per micrometer as measured by x-ray photoelectron spectroscopy.

In some embodiments, the depth is measured from an exterior surface of the alloyed metal layer.

In some embodiments, the alloyed metal layer has a composition that varies by about 20 wt. % or less over a depth of about 50 micrometers or less.

In another aspect, the disclosure provides a material that comprises an outer metal layer metallurgically bonded to a steel substrate, where the material has a composition that varies by about 20 wt. % or less over a depth of about 50 micrometers or less and corrodes at a rate of at most about 1 nanometer per hour when exposed to an oxidizing or corrosive environment.

In some embodiments, the outer metal layer comprises steel.

In some embodiments, the outer metal layer comprises stainless steel.

In some embodiments, the outer metal layer comprises chromium.

In some embodiments, the outer metal layer comprises nickel.

In some embodiments, the steel substrate comprises low-carbon steel.

In some embodiments, the steel substrate comprises carbon steel.

In some embodiments, the thickness of the outer metal layer is less than 200 micrometers.

In some embodiments, the thickness of the outer metal layer is less than 100 micrometers.

In some embodiments, the material corrodes at a rate of at most 0.5 nanometer per hour when exposed to an oxidizing environment.

In some embodiments, the material corrodes at a rate of at most 0.1 nanometer per hour when exposed to an oxidizing environment.

In some embodiments, the material corrodes at a rate of at most 0.05 nanometer per hour when exposed to an oxidizing environment.

In some embodiments, the surface of the material corrodes by at most 10 micrometers after one year.

In some embodiments, the surface of the material corrodes by at most 5 micrometers after one year.

In some embodiments, the material has no material discontinuity between the outer metal layer and the steel substrate.

In some embodiments, the oxidizing environment comprises one or more oxidizing agents.

In another aspect, the disclosure provides a material that comprises a stainless steel layer metallurgically bonded to a steel substrate, where the material has a composition that varies by about 20 wt. % or less over a depth of about 50 micrometers or less and has a corrosion resistance of at least about 1 year under the copper acetic acid spray (CASS) test.

In some embodiments, the material has a corrosion resistance of at least about 5 years under the copper acetic acid spray (CASS) test.

In some embodiments, the material has a corrosion resistance of at least about 10 years under the copper acetic acid spray (CASS) test.

In some embodiments, the thickness of the stainless steel layer is less than 200 micrometers.

In some embodiments, the thickness of the stainless steel layer is less than 100 micrometers.

In some embodiments, the steel substrate comprises low-carbon steel.

In some embodiments, the steel substrate comprises carbon steel.

In another aspect, the disclosure provides a metal-containing object that comprises a steel core at least partially coated with an alloyed metal layer having an alloying agent, where the alloyed metal layer has a thickness of less than 500 micrometers, and where the concentration of the alloying agent is at a maximum concentration in the metal-containing object and decreases by no more than 20 wt. % in the alloyed metal layer over a depth of about 50 micrometers or less as measured with x-ray photoelectron spectroscopy.

In some embodiments, the alloyed metal comprises stainless steel.

In some embodiments, the alloying agent comprises chromium.

In some embodiments, the alloying agent comprises nickel.

In some embodiments, the steel core comprises low-carbon steel.

In some embodiments, the steel core comprises carbon steel.

In some embodiments, the metal-containing object further comprises a diffusion layer between the alloyed metal layer and the steel core.

In some embodiments, the diffusion layer metallurgically bonds the alloyed metal layer with the steel core.

In some embodiments, the concentration of alloying agent decreases to substantially zero wt. % in the diffusion layer.

In some embodiments, the concentration of the alloying agent in the alloyed metal layer decreases by no more than 10 wt. %.

In some embodiments, the alloyed metal layer has a thickness of less than 250 micrometers.

In some embodiments, the alloyed metal layer has a thickness of less than 100 micrometers.

In some embodiments, the metal-containing object is metal roofing material.

In some embodiments, there is not a discontinuity between the alloyed metal layer and the steel core.

In another aspect, the disclosure provides a metal-containing object that comprises an alloying agent, where the alloying agent has a concentration of at least 10 wt. % at a depth of less than or equal to 30 micrometers from the surface of the metal-containing object, and where the alloying agent has a concentration of at most 6 wt. % at a depth of greater than 150 micrometers from the surface of the metal-containing object.

In some embodiments, at a depth of less than or equal to 30 micrometer from the surface of the metal-containing object, the concentration of the alloying agent varies by about 20 wt. % or less with depth.

In some embodiments, at a depth of less than or equal to 30 micrometer from the surface of the metal-containing object, the concentration of the alloying agent varies by about 10 wt. % or less with depth.

In some embodiments, at a depth of less than or equal to 30 micrometer from the surface of the metal-containing object, the concentration of the alloying agent varies by about 5 wt. % or less with depth.

In some embodiments, the alloying agent comprises chromium.

In some embodiments, the alloying agent comprises nickel.

In some embodiments, the alloying agent comprises iron.

In some embodiments, the alloying agent has a concentration of at least 15 wt. % at a depth of less than or equal to 50 micrometers from the surface of the metal-containing object.

In some embodiments, the alloying agent has a concentration of at least 10 wt. % at distances less than or equal to 75 micrometers from the surface of the metal-containing object.

In some embodiments, the alloying agent has a concentration of at most 4 wt. % at a depth of greater than 150 micrometers from the surface of the metal-containing object.

In some embodiments, the metal-containing object is metal roofing material.

Additional aspects and advantages of the disclosure will become readily apparent to those skilled in this art from the following detailed description, where only illustrative embodiments of the present disclosure are shown and described. As will be realized, the disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a plot of chromium concentration as a function of depth for example chromized steel;

FIG. 2 is a plot of chromium and iron concentrations as a function of depth for a precursor to an example steel product;

FIG. 3 is a cross section scanning electron microscopy (SEM) image of the precursor to an example steel product;

FIG. 4 is a plot of chromium concentrations as a function of depth for an example steel product, (solid line) the energy-dispersive X-ray spectroscopy (EDX) data as measured, (dashed line) the EDX data normalized for the concentration of chromium in the core;

FIG. 5 is a cross section SEM image of an example steel product;

FIG. 6 is a plot of chromium, nickel, and iron concentrations as a function of depth for a precursor to an example steel product;

FIG. 7 is a cross section SEM image of the precursor to an example steel product;

FIG. 8 is a plot of chromium and nickel concentrations as a function of depth for an example steel product;

FIG. 9 is a cross section SEM image of an example steel product; and

FIG. 10 is a schematic of one embodiment described herein.

While specific embodiments are illustrated in the figures, with the understanding that the disclosure is intended to be illustrative, these embodiments are not intended to limit the invention described and illustrated herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### DEFINITIONS

The term “admixture,” as used herein and as related to a plurality of metals (e.g., transition metals) means that the metals are intermixed in a given region. An admixture can also be described as a solid solution, an alloy, a homogeneous admixture, a heterogeneous admixture, a metallic phase, or one of the preceding further including an intermetallic or insoluble structure, crystal, or crystallite. In some cases, the term “admixture” as used herein expressly excludes intermixed grains or crystals or intersoluble materials. That is, the admixtures described herein may not include distinguishable grains of compositions that can form a solid solution or a single metallic phase (e.g., by heating the admixture to a temperature where the grains of compositions can inter-diffuse). Notably, an admixture can include intermetallic species as these intermetallic species may not be soluble in the “solute” or bulk metallic phase. Furthermore, the exclusion of intermixed-intersoluble materials does not limit the homogeneity of the sample. A heterogeneous admixture can include a concentration gradient of at least one of the metals in the admixture, but may not include distinguishable grains or crystals of one phase or composition intermixed with grains, with crystals, or in a solute having a second phase of composition in which the first phase of composition is soluble.

The noun “alloy,” as used herein and as related to an admixture of metals, means a specific composition of metals, e.g., transition metals, with a narrow variation in concentration of the metals throughout the admixture. One example of an alloy is 304 stainless steel that can have an iron composition that includes about 18-20 wt. % chromium (Cr), about 8-10.5 wt. % nickel (Ni), and about 2 wt. % manganese (Mn). As used herein, an alloy that occupies a specific volume may not include a concentration gradient. Such a specific volume that includes a concentration gradient can include, as an admixture, a plurality or range of alloys. An “alloying agent” can be one or more elements that alloy with one or more other elements to provide a gradual change in composition across a given depth of a material. Such gradual change in composition can provide for a product that is substantially robust with respect to other materials that may not have a gradual change in composition.

The term “concentration gradient,” as used herein refers to the regular increase or decrease in the concentration of at least one element in an admixture. In some cases, a concentration gradient is observed in an admixture where at least one element in the admixture increases or decreases from a set value to a higher/lower set value. The increase or decrease can be linear, parabolic, Gaussian, or mixtures thereof. In some cases, a concentration gradient is not a step function. A step function variation can be described as a plurality of abutting admixtures.

Layers and/or regions of the materials can be referred to as being “metallurgically bonded.” That is, the metals, alloys or admixtures that provide the composition of the layers and/or regions can be joined through a conformance of lattice structures. Intermediate layers such as adhesives or braze metal are not necessarily involved. Bonding regions can be the areas in which the metallurgical bonds between two or more metals, alloys or admixtures display a conformance of lattice structures. The conformance of lattice structures can include the gradual change from the lattice of one metal, alloy or admixture to the lattice of the metallurgically bonded metal, alloy or admixture.

While terms used herein may be commonly used in the steel industry, the compositions or regions may comprise, consist of, or consist essentially of, one or more elements. In some cases, steel is considered to be carbon steel (e.g., a mixture of at least iron, carbon, and up to about 2% total alloying elements). Alloying elements or alloying agents can include, but are not limited to, carbon (C), chromium (Cr), cobalt (Co), niobium (Nb), molybdenum (Mo), nickel (Ni), titanium (Ti), tungsten (W), vanadium (V), zirconium (Zr) or other metals. In some cases, steel or carbon steel can be a random composition of a variety of elements supported in iron. When compositions or regions are described as consisting of, or consisting essentially of, one or more elements, the concentration of non-disclosed elements in the composition or region may not detectable by energy-dispersive X-ray spectroscopy (EDX) (e.g., EDX can have a sensitivity down to levels of about 0.5 to 1 atomic percent). When the composition or region is described as consisting of one or more elements, the concentration of the non-disclosed elements in the composition or region may not be detectable or within the measurable error of direct elemental analysis, e.g., by inductively coupled plasma (ICP).

The articles “a”, “an” and “the” are non-limiting. For example, “the method” includes the broadest definition of the meaning of the phrase, which can be more than one method.

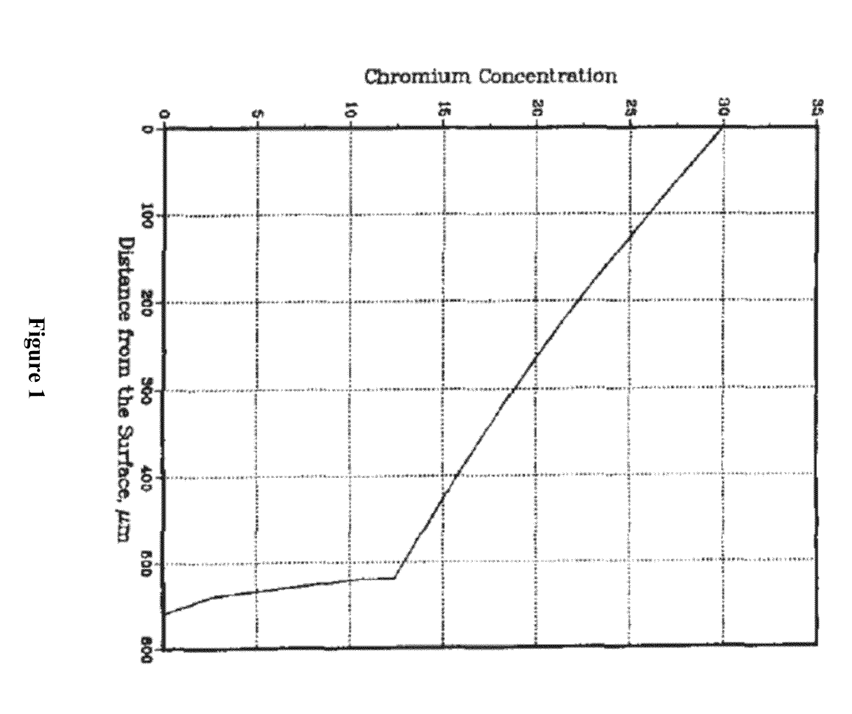

A method for protecting steel as described herein includes providing one or more stainless steel compositions on the exterior of the steel product. The product can be pre-fabricated into a given shape, such as, for example, an electronic component (e.g., phone, computer) or mechanical component (e.g., fixture). Chromizing can be a common method for the production of chromium-iron alloys (e.g., stainless steels) on the surface of steels. Chromizing steel can involve a thermal deposition-diffusion processes whereby chromium can diffuse into the steel and produce a varying concentration of chromium in the steel substrate. In some cases, the surface of the substrate has the highest chromium concentration and the chromium concentration decreases as the distance into the substrate increases. In some cases, the chromium concentration follows a diffusion function (e.g., the chromium concentration decreases exponentially as a function of distance from the substrate). Other chromizing products (e.g., as described in U.S. Pat. No. 3,312,546) can include diffusion coatings that have chromium concentrations above 20% that decrease linearly as a function of distance into the substrate (see FIG. 1). These high chromium-content coatings can appear to include a foil or layer of chromium containing material carried by the bulk substrate.

The decreasing concentration of chromium as a function of depth into the substrate can affect the corrosion resistance of the material. In some cases, abrasion of the surface continuously produces new layers with lower chromium concentrations that are less corrosion resistant than the initial surface. This undesirable effect can be due to the variable concentration of chromium in the chromized surfaces.

Explosive welding or cladding of stainless steel onto a carbon steel can produce a stainless steel layer with a consistent composition metallurgically bonded to a carbon steel substrate. This technique can overcome the variable concentrations associated with chromizing, but can be limited by the thicknesses of the flying layer, the use of high explosives, and/or the metallurgical bond that is formed. At least two types of metallurgical bonds can be observed in explosively welding metals. Under high explosive loading, the cross-section can be composed of a wave-like intermixing of the base and flying layers and under lower explosive loadings the cross-section can include an implantation of grains of the flying layer into the base layer (e.g., see Explosive welding of stainless steel-carbon steel coaxial pipes, J. Mat. Sci., 2012, 47-2, 685-695 and Microstructure of Austenitic stainless Steel Explosively Bonded to low Carbon-Steel, J. Electron Microsc. (Tokyo), 1973, 22-1, 13-18, each of which are incorporated by reference in their entirety).

In an aspect, the disclosure provides a material that includes a stainless steel layer with a consistent composition diffusion bonded to a carbon steel substrate. The material can have the corrosion resistance associated with the explosively welded stainless steel and the deep diffusion bonding observed typical of chromizing applications.

Metallurgically Bonded Steel

Provided herein are materials comprising an outer metal layer metallurgically bonded to a steel substrate. The outer metal layer can be formed by any one or more of a variety of methods. In some cases, the outer metal layer is formed by vapor deposition (e.g., chemical vapor deposition (CVD), physical vapor deposition (PVD), atomic layer deposition (ALD), and/or plasma-enhanced CVD (PECVD)). In some instances, the outer material layer is formed by electrochemical deposition (e.g., electroplating). Electroplating can use electrical current to reduce dissolved metal cations so that they form a metal coating on an electrode. Examples of methods suitable for the formation of an outer metal layer are described in U.S. patent application Ser. No. 13/629,699; U.S. patent application Ser. No. 13/799,034; and U.S. patent application Ser. No. 13/800,698, each of which is incorporated herein by reference in its entirety.

The material described here can include a variety of metallurgically bonded metals, alloys or admixtures. In some cases, the materials have a certain composition or concentration and/or variation of the compositions or concentrations as a function of depth or distance through the material (e.g., of transition metals in the metals, alloys or admixtures). In some cases, the composition or concentrations of the component metals in the metals, alloys or admixtures can be determined by energy-dispersive X-ray spectroscopy (EDX). In some instances, when a composition is described as being “approximately consistent” over a distance, in a layer, or in a region, the term means that the relative percentage of metals in that distance, layer or region is consistent within the standard error of measurement by EDX. In some cases, the moving average over the “approximately consistent” distance, layer or region has a slope of about zero when plotted as a function of concentration (y-axis) to distance (x-axis). In some instances, the concentration (or relative percentage) of the individual elements in the composition vary by less than about 5 wt. %, 4 wt. %, 3 wt. %, 2 wt. %, or 1 wt. % over the distance.

In some embodiments, the disclosure provides a steel form having a stainless steel exterior. The steel form can include a core region which carries a stainless steel coating (e.g., the steel form includes the core region, a bonding region, and a stainless steel region, where the bonding region metallurgically bonds the core region to the stainless steel region). In some cases, the steel form is defined by layers or regions that can include at least 55 wt. % iron (e.g., the steel form can be coated by organic or inorganic coatings but these coatings are not considered part of the steel form). In some cases, the core region of the steel form can include iron (e.g., at least 55 wt. % iron). In some instances, the iron concentration in the core region is greater than 98 wt. %, 99 wt. %, or 99.5 wt. %. In some embodiments, the core region can be a carbon steel having a carbon concentration of less than about 0.5 wt. %. In some cases, the core region is a carbon steel having a carbon concentration of less than about 0.25 wt. %. In some embodiments, the core region is substantially free of chromium and/or substantially free of nickel.

The stainless steel coating carried by (i.e., disposed upon) the core region can consist of a stainless steel region and a bonding region. In some cases, the bonding region can be proximal to the core region and the stainless steel region including the stainless steel exterior. The stainless steel region can have a thickness of about 1 μm to about 250 μm, about 5 μm to about 250 μm, about 10 μm to about 250 μm, about 25 μm to about 250 μm, about 50 μm to about 250 μm, about 10 μm to about 200 μm, or about 10 μm to about 100 μm.

The stainless steel region can have a stainless steel composition. As used here, a “stainless steel composition” means that the stainless steel region includes an admixture of iron and chromium. In some cases, the stainless steel composition includes a chromium concentration of about 10 wt. % to about 30 wt. % (e.g., about 10 wt. %, about 12 wt. %, about 14 wt. %, about 16 wt. %, about 18 wt. %, about 20 wt. %, about 22 wt. %, about 24 wt. %, about 26 wt. %, about 28 wt. %, or about 30 wt. %). In some cases, the stainless steel composition is approximately consistent across the thickness of the stainless steel region.

In some embodiments, in an approximately or substantially consistent stainless steel composition, the relative percentage of metals in that distance layer or region is consistent within the standard error of measurement by energy-dispersive X-ray spectroscopy (EDX). For instance, the moving average over the approximately or substantially consistent distance, layer or region has a slope of about zero when plotted as a function of concentration (y-axis) to distance (x-axis). In some embodiments, the concentration (or relative percentage) of the individual elements in the composition vary by less than about 40 wt. %, 30 wt. %, 20 wt. %, 15 wt. %, 10 wt. %, 9 wt. %, 8 wt. %, 7 wt. %, 6 wt. %, 5 wt. %, 4 wt. %, 3 wt. %, 2 wt. %, or 1 wt. % over the distance. In some cases, the concentration (or relative percentage) of the individual elements in the composition vary by less than about 40 wt. %, 30 wt. %, 20 wt. %, 15 wt. %, 10 wt. %, 9 wt. %, 8 wt. %, 7 wt. %, 6 wt. %, 5 wt. %, 4 wt. %, 3 wt. %, 2 wt. %, or 1 wt. % over a distance (e.g., depth) of at least about 10 nanometers (nm), 20 nm, 30 nm, 40 nm, 50 nm, 60 nm, 70 nm, 80 nm, 90 nm, 100 nm, 200 nm, 300 nm, 400 nm, 500 nm, 1 micrometer (micron), 2 microns, 3 microns, 4 microns, 5 microns, 10 microns, 20 microns, 30 microns, 40 microns, 50 microns, 100 microns, 200 microns, 300 microns, 400 microns, or 500 microns.

The stainless steel composition can include an admixture of iron and chromium, and can further include a transition metal selected from the group consisting of nickel, molybdenum, titanium, niobium, tantalum, vanadium, tungsten, copper, and a mixture thereof. In some embodiments, the stainless steel composition comprises an admixture of iron, chromium, and nickel, and comprises a nickel concentration of about 5 wt. % to about 20 wt. %. In some embodiments, the bonding composition can comprise or consist essentially of iron, chromium and nickel.

Stainless steel layers of the disclosure can be free or substantially free of defects, such as cracks. Such cracks can penetrate into various depths of the layers and, in some cases, expose underlying layers. Layers of the disclosure can have cracks at a density of at most about 50%, 40%, 30%, 20%, 15%, 10%, 9%, 8%, 7%, 6%, 5%, 4%, 3%, 2%, 1% (by surface area) in an area of at least about 1 μm², 5 μm², 10 μm², 20 μm², 30 μm², 40 μm², 50 μm², 100 μm², 500 μm², 1000 μm², 5000 μm², 10000 μm², 50000 μm², 100000 μm², or 500000 μm². In some instances, there are about 2 to 5 cracks in an area of about 80,000 μm².

In some embodiments, the stainless steel composition has a chromium concentration of about 16 wt. % to about 25 wt. %, and nickel concentration of about 6 wt. % to about 14 wt. %. In some embodiments, the stainless steel composition consists essentially of iron, chromium and nickel.

In some cases, the stainless steel composition has a chromium concentration of about 10.5 wt. % to about 18 wt. %. In some embodiments, the stainless steel composition consists essentially of iron and chromium and the bonding composition consists essentially of iron and chromium.

In some cases, the stainless steel coating includes the stainless steel region and the bonding region which can be positioned between the stainless steel region and the core region. The bonding region can have a thickness that is greater than 1 μm and less than the thickness of the stainless steel region. In some cases, the bonding region has a thickness of about 5 μm to about 200 μm, about 5 μm to about 100 μm, or about 10 μm to about 50 μm.

The bonding region can have a bonding composition, which can include an admixture of iron and chromium. In some cases, the bonding composition further includes a chromium concentration proximal to the stainless steel region that is approximately equal to the chromium concentration of the stainless steel region and having a chromium concentration proximal to the core region (e.g., that has less than about 5 wt. %, about 4 wt. %, about 3 wt. %, about 2 wt. %, about 1 wt. %, or about 0.5 wt. % chromium). That is, the chromium concentration can decrease through the boding region to a concentration that is less than half of the concentration in the stainless steel region (e.g., decreases to a concentration that is approximately equal to the concentration of chromium in the core region). The chromium concentration gradient in the bonding region can include a linear decrease in chromium concentration or a sigmoidal decrease in chromium concentration for example.

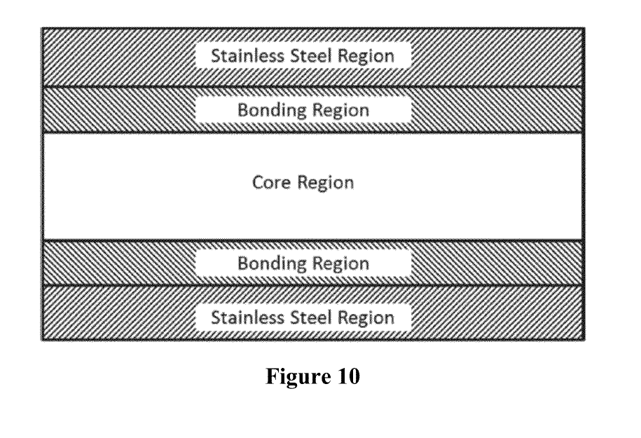

Another aspect of the disclosure is a steel sheet that includes a plurality of regions, including a first stainless steel region, a first bonding region positioned between the first stainless steel region and a core region, the core region, a second bonding region positioned between the core region and a second stainless steel region, and the second stainless steel region (e.g., see FIG. 10). In such cases, the first stainless steel region can have a thickness of about 1 μm to about 250 μm; the first bonding region can have a thickness that is greater than 1 μm and less than the thickness of the first stainless steel region; the core region can have a thickness of about 100 μm to about 4 mm; the second stainless steel region can have a thickness of about 1 μm to about 250 μm; and the second bonding region can have a thickness that is greater than 1 μm and less than the thickness of the second stainless steel region.

In some cases, the core region has a core composition that comprises at least 70 wt. % iron. In some instances, the iron concentration in the core region is greater than 75 wt. %, 85 wt. %, 90 wt. %, 95 wt. %, 98 wt. %, 99 wt. %, or 99.5 wt. %. In some cases, the core region is a carbon steel having a carbon concentration of less than about 0.5 wt. %. In some cases, the core region is a carbon steel having a carbon concentration of less than about 0.25 wt. %. In some embodiments, the core region is substantially free of chromium.

The first and second stainless steel regions can have stainless steel compositions that are approximately consistent across the thickness of the respective stainless steel regions. These stainless steel compositions can individually include an admixture of iron and chromium with a chromium concentration of about 10 wt. % to about 30 wt. %. In some cases, the chromium concentration can be about 10 wt. %, about 12 wt. %, about 14 wt. %, about 16 wt. %, about 18 wt. %, about 20 wt. %, about 22 wt. %, about 24 wt. %, about 26 wt. %, about 28 wt. %, or about 30 wt. %.

The first and second bonding regions can have bonding compositions that include an admixture of iron and chromium. Individually, the bonding regions can have chromium concentrations proximal to the respective stainless steel regions that are approximately equal to the chromium concentration of the stainless steel region. In some cases, the chromium concentrations proximal to the core region are less than about 5 wt. %, about 4 wt. %, about 3 wt. %, about 2 wt. %, about 1 wt. %, or about 0.5 wt. % chromium. In some cases, the chromium concentrations proximal to the core region are approximately equal to the chromium concentration in the core region (e.g., the individual bonding regions each have a chromium concentration gradient). The chromium concentration gradient in the bonding region can include a linear decrease in chromium concentration or a sigmoidal decrease in chromium concentration.

In some embodiments, the first and second stainless steel composition individually comprise an admixture of iron, chromium, and nickel, with a nickel concentration of about 5 wt. % to about 20 wt. %. The respective first and second bonding compositions can also include nickel.

In some embodiments, the first and second stainless steel composition individually comprise an admixture of iron, chromium, and a transition metal selected from the group consisting of nickel, molybdenum, titanium, niobium, tantalum, vanadium, tungsten, copper, and a mixture thereof. The respective bonding compositions can also include the selected transition metal(s).

In some cases, the steel sheet that includes the regions described herein have a thickness of about 0.1 mm to about 4 mm. The thickness can be the lesser of the height, length, or width of the material. For a typical sheet, the length and width are multiple orders of magnitude greater than the height (or thickness). For example, the steel sheet can be a steel coil with a width of about 1 meter to about 4 meters and a length of greater than 50 meters.

The individual stainless steel regions can have the same or different thicknesses. In some instances, the first and second stainless steel regions have approximately the same thickness (e.g., ±5%). In one example, the first stainless steel region has a thickness of about 10 μm to about 100 μm. In another example, the second stainless steel region has a thickness of about 10 μm to about 100 μm. The individual bonding regions can have the same or different thicknesses. In some cases, the first and second bonding regions have approximately the same thickness (e.g., ±5%). In another example, the first bonding region has a thickness of about 5 μm to about 100 μm. In still another example, the second bonding region has a thickness about 5 μm to about 100 μm.

In another aspect, described herein is a steel form that includes a brushed stainless steel surface carried by (i.e., disposed upon) a stainless steel region. In some embodiments, the stainless steel region can have a thickness of about 5 μm to about 200 μm, can have an approximately consistent stainless steel composition that includes an admixture of iron and chromium, and can have a chromium concentration of about 10 wt. % to about 30 wt. %. The stainless steel region can be carried by a bonding region. In some cases, the bonding region has a thickness of about 5 μm to about 200 μm but less than the thickness of the stainless steel region. The bonding region can metallurgically bond the stainless steel region to a core region. The core region can have a core composition that includes at least 85 wt. % iron. The bonding region can further include a bonding composition which includes an admixture of iron and chromium, and a bonding region concentration gradient that decreases from a chromium concentration proximal to the stainless steel region that is approximately equal to the chromium concentration of the stainless steel region to a chromium concentration proximal to the core region that is less than about 1 wt. %.

In some cases, the products are free of plastic deformation. As used herein, “plastic deformation” is the elongation or stretching of the grains in a metal or admixture brought about by the distortion of the metal or admixture. For example, cold rolled steel can display plastic deformation in the direction of the rolling. Plastic deformation in steel can be observable and quantifiable through the investigation of a cross-section of the steel. The products described here can be substantially free of plastic deformation (e.g., the products include less than 15%, 10%, or 5% plastic deformation). In some cases, the products are essentially free of plastic deformation (e.g., the products include less than 1% plastic deformation). In some cases, the products described herein are free of plastic deformation (e.g., plastic deformation in the products is not observable by investigation of a cross section of the product). In some cases, the products described herein exhibit plastic deformation. The material can be full-hard (i.e., material that is highly stressed). In some embodiments, the substrate is used directly off of a cold mill (i.e., full-hard substrate). In some instances, full-hard substrate helps with the diffusion process, achieving rapid mixing during the re-crystallization process. The materials and methods described herein can use varying amounts of cold work (e.g., half-hard or quarter-hard substrate).

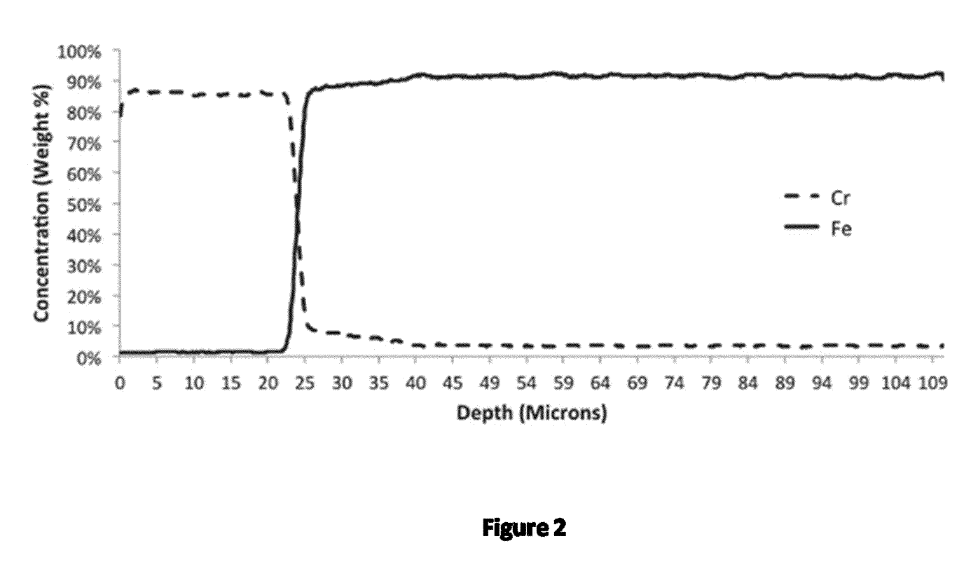

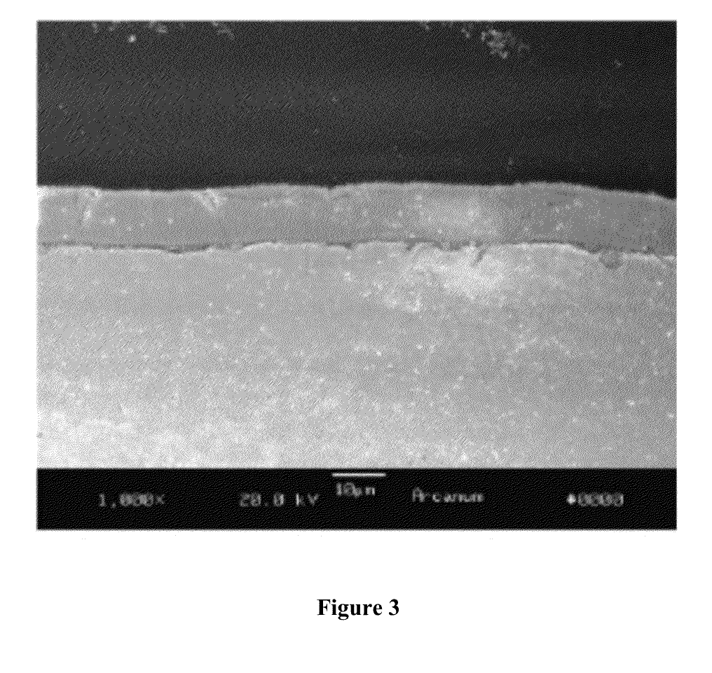

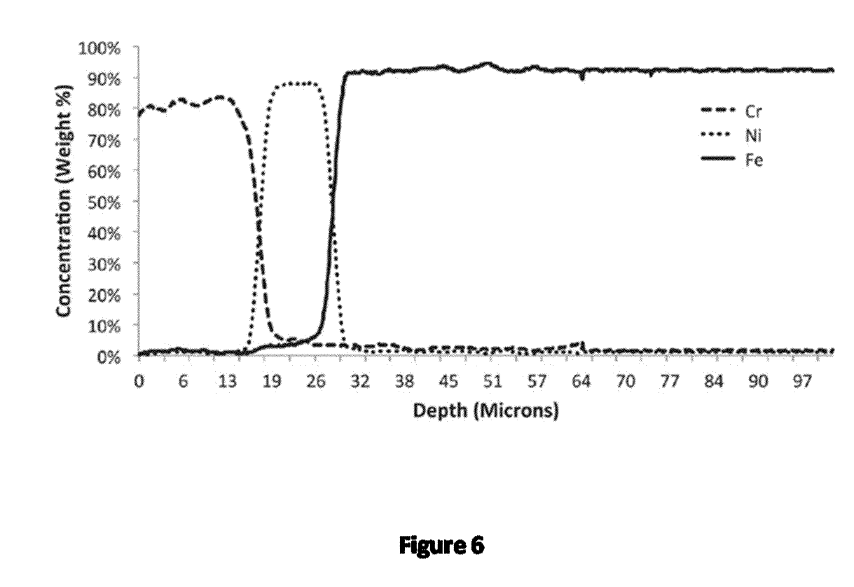

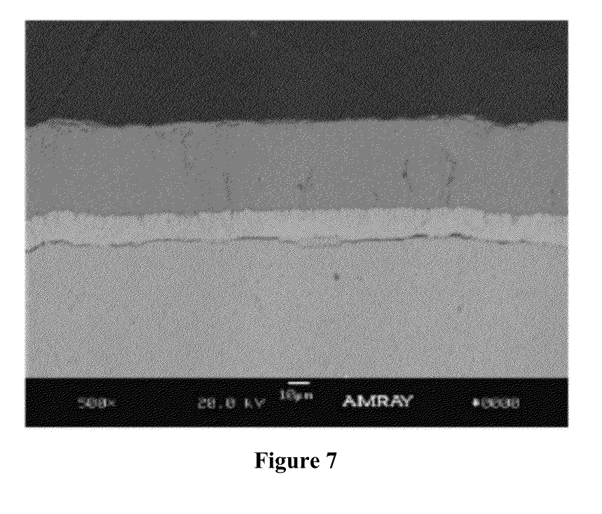

The products (e.g., which include a stainless steel layer or region carried by a steel or carbon steel substrate or core) can be manufactured by the low temperature deposition of chromium onto a starting substrate that becomes the core region. Available techniques for the deposition of chromium onto the starting substrate include, but are not limited to, physical vapor deposition, chemical vapor deposition, metal-organic chemical vapor deposition, sputtering, ion implantation, electroplating, electroless plating, pack cementation, the ONERA™ process, salt bath processes, chromium-cryolite processes, Alphatising process, or the like. In some instances, the chromium is deposited in a non-compact layer upon the starting substrate. In some cases, the chromium is deposited as a layer that consists essentially of chromium. FIGS. 2 and 3 show energy-dispersive X-ray spectroscopy (EDX) and scanning electron microscopy (SEM) data of the as-deposited chromium layer on the carbon steel substrate. FIG. 2 shows the approximate weight percentages of the as-deposited chromium and iron in the carbon steel substrate. FIG. 3 shows an SEM image of the cross section of the chromium deposited on the carbon steel substrate. In some cases, the chromium is deposited as an admixture of iron and chromium. In some instances, the chromium is deposited as an admixture of chromium and an element selected from the group consisting of nickel, molybdenum, titanium, niobium, tantalum, vanadium, tungsten, copper, and a mixture thereof. In some cases, a plurality of layers of chromium and an element selected from the group consisting of nickel, molybdenum, titanium, niobium, tantalum, vanadium, tungsten, copper, and a mixture thereof are deposited onto the starting substrate. FIG. 6 and FIG. 7 show EDX and SEM data of as-deposited nickel and chromium layers on the carbon steel substrate. FIG. 6 shows the approximate weight percentages of the as-deposited chromium, as-deposited nickel, and iron in the carbon steel substrate. FIG. 7 shows an SEM image of the cross section of the chromium and nickel carried by the carbon steel substrate.

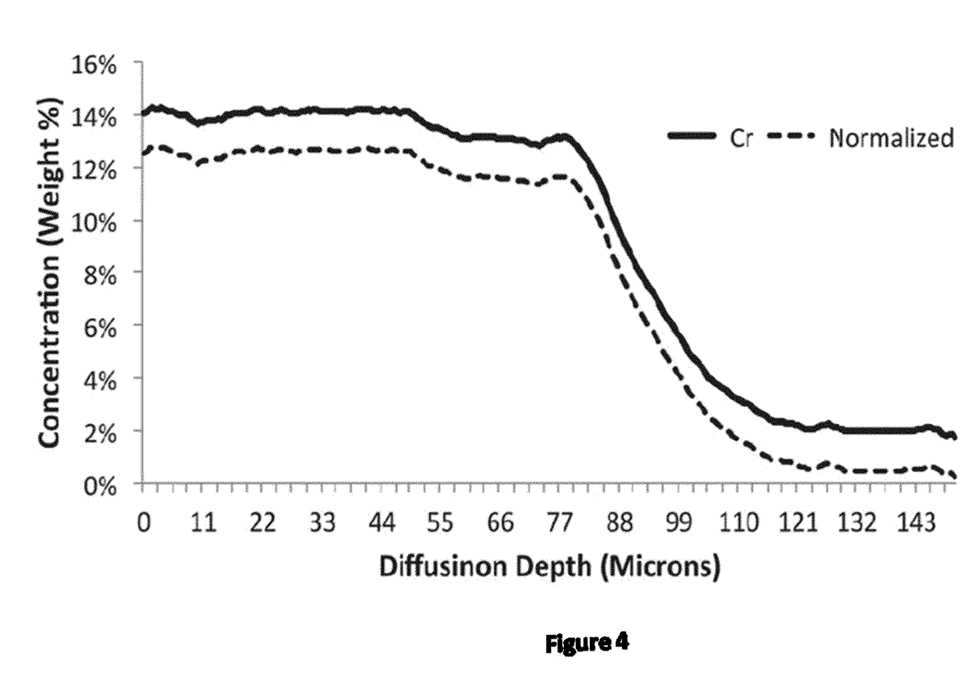

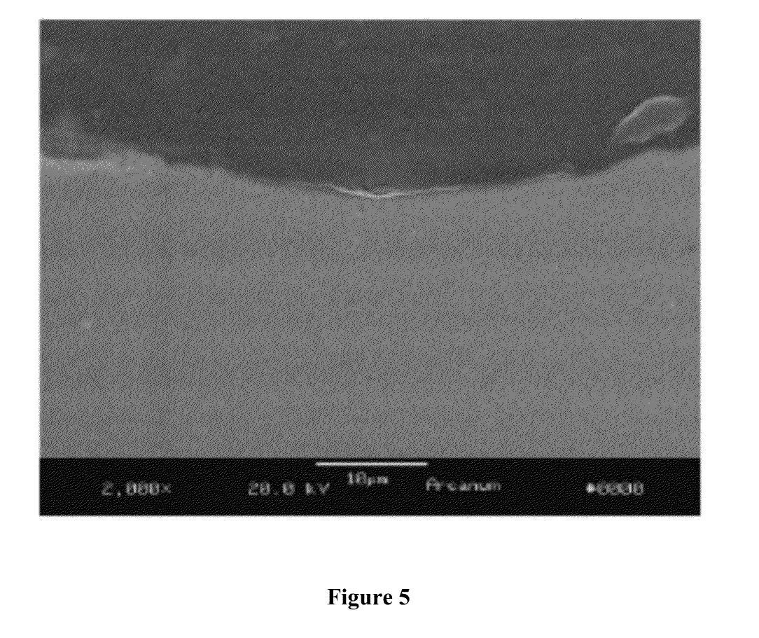

Following the deposition of the chromium onto the starting substrate, the deposited chromium and any other deposited metals can be heated to a temperature in a range of about 800° C. to about 1200° C., or about 1000° C. FIGS. 4 and 5 show EDX and SEM data of a 400 series stainless steel carried by a carbon steel core that was made by heating the deposited chromium, e.g., as shown in FIGS. 2 and 3. FIG. 4 shows the approximate weight percentage of chromium (as measured and normalized) as a function of depth. The stainless steel region can be comparable to a stainless steel composition designation selected from the group consisting of 403 SS, 405 SS, 409 SS, 410 SS, 414 SS, 416 SS, 420 SS, and 422 SS. The designation of the composition of the stainless steel layer can be affected by the concentration of trace elements in the carbon steel substrate (e.g., nickel, carbon, manganese, silicon, phosphorus, sulfur, and nitrogen), by the addition of one or more trace elements to the as deposited chromium, or by the addition of one or more trace elements by post treatment of the as-deposited chromium (e.g., by solution, deposition, or ion implantation methods). FIG. 5 shows an SEM cross section of the stainless steel region, bonding region and core regions notably omitting any observable distinction (e.g., interface) between the respective regions.

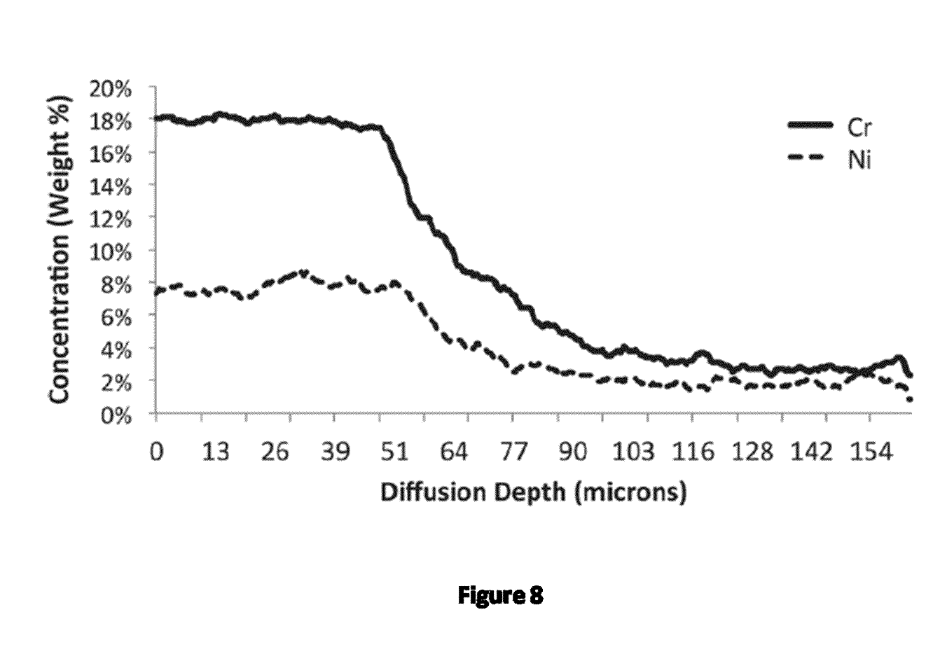

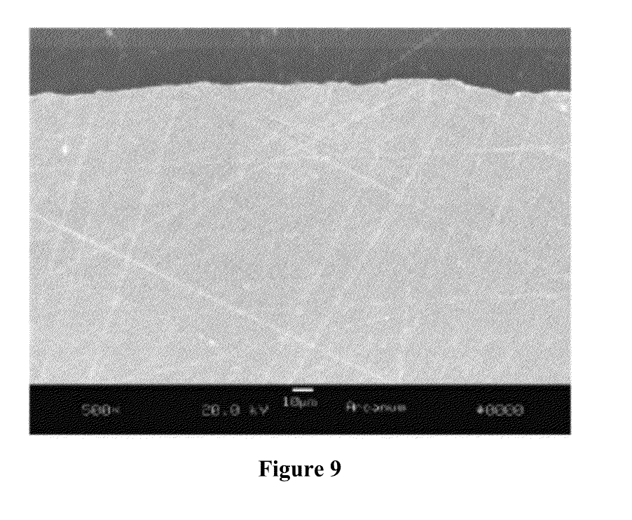

FIGS. 8 and 9 show EDX and SEM data of a 300 series stainless steel carried by a carbon steel core that was made by heating the deposited chromium, e.g., as shown in FIGS. 6 and 7. FIG. 8 shows the approximate weight percentages of chromium and nickel as a function of depth. The stainless steel region is comparable to a stainless steel composition designation selected from the group consisting of 301 SS, 302 SS, 303 SS, and 304 SS. The designation of the composition of the stainless steel layer can be affected by the concentration of trace elements in the carbon steel substrate (e.g., carbon, manganese, silicon, phosphorus, sulfur, and nitrogen), by the addition of one or more trace elements to the as deposited chromium, or by the addition of one or more trace elements by post treatment of the as-deposited chromium (e.g., by solution, deposition, or ion implantation methods). Furthermore, the designation of the composition of the stainless steel is affected by the concentrations of the chromium and nickel in the stainless steel layer; these concentrations can be increased or decreased independently. FIG. 9 shows a SEM cross section of the stainless steel region, bonding region and core regions notably omitting any observable distinction (e.g., interface) between the respective regions.

The determination of the thickness and composition of the stainless steel region, bonding region, and optionally the core region is determined by cross-sectional analysis of a sample of the products described herein. In some cases, the sample is defined by a 1 cm by 1 cm region of the face of the product. The sample can then be cut through the center of the 1 cm by 1 cm region and the face exposed by the cut can be polished on a Buehler EcoMet 250 grinder-polisher. In some cases, a five step polishing process includes 5 minutes at a force of 6 lbs. with a Buehler 180 Grit disk, 4 minutes at a force of 6 lbs. with a Hercules S disk and a 6 μm polishing suspension, 3 minutes at a force of 6 lbs. with a Trident 3/6 μm disk and a 6 μm polishing suspension, 2 minutes at a force of 6 lbs. with a Trident 3/6 μm disk and a 3 μm polishing suspension, and then 1.5 minutes at a force of 6 lbs. with a microcloth disk and a 0.05 μm polishing suspension. The cut and polished face can then be in an instrument capable of energy-dispersive X-ray spectroscopy (EDX). The above provided grinding-polishing procedure may cross-contaminate distinct layers. The contamination can be consistent across the polished face. In some cases, a baseline measurement of a region that is free of a first element may display a greater than baseline concentration of the first element by EDX (see, for example, FIG. 4). The increase in the base line can be dependent on the area of the regions polished and the concentration of the respective elements in the polished faces.

Properties of the Materials

In an aspect of the disclosure, a material comprises an alloyed metal layer having an alloying agent, the alloyed metal layer being coupled to a substrate (e.g., a steel substrate) with the aid of a diffusion layer between the alloyed metal layer and the substrate. In some cases, the amount of alloying agent in the diffusion layer changes with depth at a rate between about −0.01% per micrometer and −5.0% per micrometer as measured, for example, by x-ray photoelectron spectroscopy (XPS). X-ray photoelectron spectroscopy (XPS) generally refers to a quantitative spectroscopic technique known in the art that, in a surface-sensitive fashion, can measure one or more of the elemental composition, empirical formula, chemical state and electronic state of the elements that exist within a material. In some cases, x-ray photoelectron spectroscopy can measure elemental composition. In some cases, XPS spectra can be obtained by irradiating a material with X-rays and measuring the kinetic energy and number of electrons that escape from the material being analyzed.

The amount of alloying agent in the diffusion layer can change with depth at any suitable rate. In some cases, the amount of alloying agent in the diffusion layer as measured by x-ray photoelectron spectroscopy changes with depth at a rate of about −0.001%, about −0.005%, about −0.01%, about −0.05%, about −0.1%, about −0.5%, about −1%, or about −5% per micrometer. In some cases, the amount of alloying agent changes with depth at a rate of at most about −0.001%, at most about −0.005%, at most about −0.01%, at most about −0.05%, at most about −0.1%, at most about −0.5%, at most about −1%, or at most about −5% at most about per micrometer as measured by x-ray photoelectron spectroscopy. In some cases, the amount of alloying agent in the diffusion layer changes with depth at a rate between about −0.05% per micrometer and −1.0% per micrometer as measured by x-ray photoelectron spectroscopy. In some cases, the amount of alloying agent in the diffusion layer changes with depth at a rate between about −0.15% per micrometer and −0.60% per micrometer as measured by x-ray photoelectron spectroscopy. In some cases, the depth is measured from an exterior surface of the alloyed metal layer.

In some cases, the diffusion layer provides a metallurgical bond between the alloyed metal layer and the substrate. In some cases, the alloyed metal layer comprises stainless steel.

The alloying agent can be any suitable material. In some cases, the alloying agent comprises chromium, nickel, iron, or any combination thereof. The substrate can be any suitable material. In some cases, the substrate comprises a steel substrate. In some cases, a steel substrate comprises stainless steel, low-carbon steel and/or carbon steel.

The alloyed metal layer can have any suitable thickness. In some cases, the thickness of the alloyed metal layer is about 500 micrometers, about 300 micrometers, about 200 micrometers, about 100 micrometers or about 50 micrometers. In some cases, the thickness of the alloyed metal layer is at least about 500 micrometers, at least about 300 micrometers, at least about 200 micrometers, at least about 100 micrometers or at least about 50 micrometers. In some cases, the thickness of the alloyed metal layer is at most about 500 micrometers, at most about 300 micrometers, at most about 200 micrometers, at most about 100 micrometers or at most about 50 micrometers. In some cases, the thickness of the alloyed metal layer is less than about 500, less than about 300, less than about 200, less than about 100, less than about 50, less than about 25 or less than about 10 micrometers.

In some embodiments, the alloyed metal layer has a composition that varies by about 90 wt. % (w/w), 80 wt. %, 70 wt. %, 60 wt. %, 50 wt. %, 40 wt. %, 30 wt. %, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. % or less over a depth of about 500 micrometers, 400 micrometers, 300 micrometers, 200 micrometers, 100 micrometers, 75 micrometers, 50 micrometers, 45 micrometers, 40 micrometers, 35 micrometers, 30 micrometers, 25 micrometers, 20 micrometers, 15 micrometers, 10 micrometers, 5 micrometers or less. In some embodiments, the alloyed metal layer has a composition that varies by about 20 wt. % or less over a depth of about 50 micrometers or less.

In an aspect, a material comprises an outer metal layer metallurgically bonded to a steel substrate, the material having a high durability as measured by contact mode atomic force microscopy (AFM). Under static mode AFM, static tip deflection can be used as a feedback signal. Because the measurement of a static signal is prone to noise and drift, low stiffness cantilevers can be used to boost the deflection signal. However, close to the surface of the material, attractive forces can be quite strong, causing the tip to “snap-in” to the surface. Static mode AFM can be done in contact where the overall force is repulsive. In contact mode AFM, the force between the tip and the surface is kept constant during scanning by maintaining a constant deflection.

In some cases, a material passes durability tests for the American Society for Testing and Materials (ASTM). ASTM's durability of material standards can provide procedures for carrying out environmental exposure tests to determine the durability, service life, and weathering behavior of certain materials. These tests can be conducted to examine and evaluate the algal resistance, light exposure behavior, activation spectrum, spectral irradiance and distribution, and microbial susceptibility of materials, which can include metals, polymeric materials, glass, and plastic films. These standards can also present the recommended calibration and operational procedures for the instruments used in conducting such tests such as pyrheliometer, UV radiometer and spectroradiometer, pyranometer, carbon arc, fluorescent, and xenon arc light apparatuses, metal black panel and white panel temperature devices, and sharp cut-on filter. These durability of material standards can be useful to manufacturers and other users concerned with such materials and products in understanding their resilience and stability mechanism.

In another aspect, the disclosure provides a material that comprises an outer metal layer metallurgically bonded to a steel substrate, where the material has a composition that varies by about 95 wt. % (w/w), 90 wt. %, 80 wt. %, 70 wt. %, 60 wt. %, 50 wt. %, 40 wt. %, 30 wt. %, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. % or less over a depth of about 500 micrometers, 400 micrometers, 300 micrometers, 200 micrometers, 100 micrometers, 75 micrometers, 50 micrometers, 45 micrometers, 40 micrometers, 35 micrometers, 30 micrometers, 25 micrometers, 20 micrometers, 15 micrometers, 10 micrometers, 5 micrometers or less.

The outer metal layer can be any suitable material. In some cases, the outer metal layer comprises steel. In some instances, the outer metal layer comprises stainless steel. In some cases, the outer metal layer comprises chromium, nickel, or a combination thereof. The steel substrate can be any suitable steel. In some instances, the steel substrate comprises low-carbon steel. In some instances, the steel substrate comprises carbon steel.

The outer metal layer can have any suitable thickness. In some cases, the thickness of the outer metal layer is about 500 micrometers, about 300 micrometers, about 200 micrometers, about 100 micrometers or about 50 micrometers. In some cases, the thickness of the outer metal layer is at least about 500 micrometers, at least about 300 micrometers, at least about 200 micrometers, at least about 100 micrometers or at least about 50 micrometers. In some cases, the thickness of the outer metal layer is at most about 500 micrometers, at most about 300 micrometers, at most about 200 micrometers, at most about 100 micrometers or at most about 50 micrometers. In some cases, the thickness of the outer metal layer is less than about 500 micrometers, less than about 300 micrometers, less than about 200 micrometers, less than about 100 micrometers, less than about 50 micrometers, less than about 25 micrometers or less than about 10 micrometers.

In some cases, the outer metal layer is configured such that it does not become dislodged from the steel substrate when contacted by the AFM. The steel substrate can comprise low-carbon steel or carbon steel. In some cases, the metallurgical bond comprises a diffusion layer (e.g., such that there is not a discontinuity of material composition where the outer metal layer and steel substrate come into contact).

In some embodiments, a material may corrode when exposed to an oxidizing environment or corrosive environment. An oxidizing environment can include one or more oxidizing agents. An oxidizing agent can include oxygen (O₂), water (H₂O) and/or hydrogen peroxide (H₂O₂). In some cases, the material has no discontinuity between the outer metal layer and the steel substrate. In some cases, the material passes the ASTM B117 test (e.g., that includes a salt spray and condensing humidity).

The oxidizing environment can be any suitable environment (e.g., comprising air, water, chloride ions and/or peroxide).

In some cases, an oxidizing or corrosive environment is at a temperature of at least about 1° C., 5° C., 10° C., 15° C., 20° C., 25° C., 30° C., 40° C., 50° C., 60° C., 70° C., 80° C., 90° C., or 100° C. The oxidizing or corrosive environment can be at a pressure of at least 1 atmosphere (atm), 2 atm, 3 atm, 4 atm, 5 atm, 6 atm, 7 atm, 8 atm, 9 atm, 10 atm, 20 atm, 30 atm, 40 atm, 50 atm, 60 atm, 70 atm, 80 atm, 90 atm, or 100 atm.

In some examples, a corrosive environment includes an acid. Examples of acids include sulfuric acid, sulfurous acid, hydrochloric acid and hydrofluoric acid. In other examples, the corrosive environment includes a base. Examples of bases include calcium oxide, magnesium oxide, potassium hydroxide, sodium hydroxide, calcium hydroxide, calcium carbonate, potassium carbonate, sodium carbonate, sodium sesquicarbonate, sodium silicate, calcium silicate, magnesium silicate or calcium aluminate.

The material can corrode at any suitably low rate when, for example, exposed to an oxidizing or corrosive environment. In some cases, the material corrodes at a rate of at most about 0.01 nanometers per hour, at most about 0.05 nanometers per hour, at most about 0.1 nanometers per hour, at most about 0.5 nanometers per hour, at most about 1 nanometer per hour, or at most about 5 nanometers per hour when exposed to an oxidizing or corrosive environment. In some cases, the material corrodes at a rate of about 0.01 nanometers per hour, about 0.05 nanometers per hour, about 0.1 nanometers per hour, about 0.5 nanometers per hour, about 1 nanometer per hour, or about 5 nanometers per hour when exposed to an oxidizing or corrosive environment. In some cases, the oxidizing or corrosive environment comprises 5% sodium chloride (NaCl) dissolved in a 3% hydrogen peroxide (H₂O₂) water mixture at room temperature.

The material can last a long time. In some cases, the surface of the material is corroded by about 0.1 micrometers, about 0.5 micrometers, about 1 micrometers, about 5 micrometers, about 10 micrometers, or about 50 micrometers after one year. In some cases, the surface of the material is corroded by at most about 0.1 micrometers, at most about 0.5 micrometers, at most about 1 micrometers, at most about 5 micrometers, at most about 10 micrometers, or at most about 50 micrometers after one year.

An additional aspect of the disclosure provides a material that comprises a stainless steel layer metallurgically bonded to a steel substrate, where the material has a composition that varies by about 95 wt. % (w/w), 90 wt. %, 80 wt. %, 70 wt. %, 60 wt. %, 50 wt. %, 40 wt. %, 30 wt. %, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. % or less over a depth of about 500 micrometers, 400 micrometers, 300 micrometers, 200 micrometers, 100 micrometers, 75 micrometers, 50 micrometers, 45 micrometers, 40 micrometers, 35 micrometers, 30 micrometers, 25 micrometers, 20 micrometers, 15 micrometers, 10 micrometers, 5 micrometers or less. In some embodiments, the material can have a corrosion resistance of at least about 1 year under the copper acetic acid spray (CASS) test. Conditions for the CASS test are known in the art and include mixtures of acetic acid and copper chloride. Another suitable testing procedure is the acetic acid test (ASS). In some cases, the material passes the ASTM B117 test (e.g., that includes a salt spray and condensing humidity).

The material can have a high resistance to corrosion. In some cases, the material has a corrosion resistance of about 5 years, about 10 years, about 15 years, about 20 years, about 25 years, or about 30 years under the copper acetic acid spray (CASS) test. In some cases, the material has a corrosion resistance of at least about 5 years, at least about 10 years, at least about 15 years, at least about 20 years, at least about 25 years, or at least about 30 years under the copper acetic acid spray (CASS) test.

The stainless steel layer can have any suitable thickness. In some cases, the thickness of the stainless steel layer is about 500 micrometers, about 300 micrometers, about 200 micrometers, about 100 micrometers or about 50 micrometers. In some cases, the thickness of the stainless steel layer is at least about 500 micrometers, at least about 300 micrometers, at least about 200 micrometers, at least about 100 micrometers or at least about 50 micrometers. In some cases, the thickness of the stainless steel layer is at most about 500 micrometers, at most about 300 micrometers, at most about 200 micrometers, at most about 100 micrometers or at most about 50 micrometers. In some cases, the thickness of the stainless steel layer is less than 500 micrometers, less than 300 micrometers, less than 200 micrometers, less than 100 micrometers, less than 50 micrometers, less than 25 micrometers or less than 10 micrometers. In an aspect of the disclosure, a metal-containing object comprises a steel core at least partially coated with an alloyed metal layer having an alloying agent, where the alloyed metal layer has a thickness of less than 500 micrometers, where the concentration of alloying agent has a maximum concentration in the metal-containing object and where the concentration of the alloying agent in the alloyed metal layer decreases by no more than 95% wt. %, 90 wt. %, 80 wt. %, 70 wt. %, 60 wt. %, 50 wt. %, 40 wt. %, 30 wt. %, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, or 1 wt. % over a depth of about 500 micrometers, 400 micrometers, 300 micrometers, 200 micrometers, 100 micrometers, 75 micrometers, 50 micrometers, 45 micrometers, 40 micrometers, 35 micrometers, 30 micrometers, 25 micrometers, 20 micrometers, 15 micrometers, 10 micrometers or less as measured with x-ray photoelectron spectroscopy. In some cases, the metal-containing object further comprises a diffusion layer between the alloyed metal layer and the steel core. In some instances, the diffusion layer metallurgically bonds the alloyed metal layer with the steel core. In some cases, there is not a discontinuity between the alloyed metal layer and the steel core.

The concentration of the alloying agent can decrease to any suitable value in a diffusion layer and/or the alloyed metal layer. In some embodiments, the concentration of alloying agent decreases to substantially zero wt. % in a diffusion layer. In some cases, the concentration of the alloying agent in the alloyed metal layer decreases by about 5 wt. %, about 10 wt. %, about 20 wt. %, about 30 wt. %, about 40 wt. %, about 50 wt. %, about 60 wt. %, about 70 wt. %, about 80 wt. %, about 90 wt. %, or about 95 wt. %. In some cases, the concentration of the alloying agent in the alloyed metal layer decreases by no more than about 5%, no more than about 10 wt. %, no more than about 20 wt. %, no more than about 30 wt. %, no more than about 40 wt. %, no more than about 50 wt. %, no more than about 60 wt. %, no more than about 70 wt. %, no more than about 80 wt. %, no more than about 90 wt. %, or no more than about 95 wt. %. In some cases, the concentration of the alloying agent in the alloyed metal layer decreases by at least about 5 wt. %, at least about 10 wt. %, at least about 20 wt. %, at least about 30 wt. %, at least about 40 wt. %, at least about 50 wt. %, at least about 60 wt. %, at least about 70 wt. %, at least about 80 wt. %, at least about 90 wt. %, or at least about 95 wt. % compared with the maximum concentration in the metal-containing object.

The alloying agent can be any suitable material. In some cases, the alloying agent comprises chromium, nickel, iron, or any combination thereof. In some cases, the steel core comprises low-carbon steel and/or carbon steel. Moreover, in some embodiments, the alloyed metal layer comprises stainless steel.

The alloyed metal layer can have any suitable thickness. In some cases, the thickness of the alloyed metal layer is about 500 micrometers, about 300 micrometers, about 200 micrometers, about 100 micrometers or about 50 micrometers. In some cases, the thickness of the alloyed metal layer is at least about 500 micrometers, at least about 300 micrometers, at least about 200 micrometers, at least about 100 micrometers or at least about 50 micrometers. In some cases, the thickness of the alloyed metal layer is at most about 500 micrometers, at most about 300 micrometers, at most about 200 micrometers, at most about 100 micrometers or at most about 50 micrometers. In some cases, the thickness of the allowed metal layer is less than 500 micrometers, less than 450 micrometers, less than 400 micrometers, less than 350 micrometers, less than 300 micrometers, less than 250 micrometers, less than 200 micrometers, less than 150 micrometers, less than 100 micrometers, less than 50 micrometers, less than 25 micrometers or less than 10 micrometers.

In an aspect of the disclosure, a metal-containing object comprises an alloying agent, where the alloying agent has a concentration of at least 95 wt. %, at least 90 wt. %, at least 80 wt. %, at least 70 wt. %, at least 60 wt. %, at least 50 wt. %, at least 40 wt. %, at least 30 wt. %, at least 20 wt. % or at least 10% wt. % at a depth of less than or equal to 30 micrometers, 25 micrometers, 20 micrometers, 15 micrometers, 10 micrometers, or 5 micrometers from the surface of the object, and where the alloying agent has a concentration of at most 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6% wt. %, 5 wt. %, 4 wt. %, 3 wt. %, 2 wt. %, or 1 wt. % at a depth of greater than 150 micrometers from the surface of the object. In some cases, the alloying agent has a concentration of at least 15 wt. % at a depth of less than or equal to 50 micrometers from the surface of the object. In some cases, the alloying agent has a concentration of at least 10 wt. % at distances less than or equal to 75 micrometers from the surface of the object. In some cases, the alloying agent has a concentration of at most 4 wt. % at a depth of greater than 150 micrometers from the surface of the object.

In some embodiments, at a depth of less than or equal to 30 micrometers, 25 micrometers, 20 micrometers, 15 micrometers, 10 micrometers or 5 micrometers from the surface of the metal-containing object, the concentration of the alloying agent varies by about 95 wt. %, 90 wt. %, 80 wt. %, 70 wt. %, 60 wt. %, 50 wt. %, 40 wt. %, 30 wt. %, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. % or less with depth. In some embodiments, at a depth of less than or equal to 30 micrometers from the surface of the metal-containing object, the concentration of the alloying agent varies by at most about 20 wt. %, at most about 19 wt. %, at most about 18 wt. %, at most about 17 wt. %, at most about 16 wt. %, at most about 15 wt. %, at most about 14 wt. %, at most about 13 wt. %, at most about 12 wt. %, at most about 11 wt. %, at most about 10 wt. %, at most about 9 wt. %, at most about 8 wt. %, at most about 7 wt. %, at most about 6 wt. %, at most about 5 wt. %, at most about 4 wt. %, at most about 3 wt. %, at most about 2 wt. %, at most about 1 wt. % or less with depth.

The alloying agent can be any suitable material. In some cases, the alloying agent comprises chromium, nickel, iron, or any combination thereof.

The materials described herein, including metal-containing objects described elsewhere herein, can be or can be formed into any suitable object or product. Non-limiting examples include wire, rods, tubes (having an inner and/or outer diameter), formed parts, metal roofing material, electronic devices, cooking appliances, automobile parts, sporting equipment, bridges, buildings, structural steel members, construction equipment, roads, railroad tracks, ships, boats, trains, airplanes, flooring material, and the like.

The wire, rods, tubes, structural steel members, etc. can be used in any suitable application. In some cases, the materials described herein have properties, a cost and/or form factors that allow for new applications not practical with previous materials. For example, lashing wire can be used to connect wires (e.g., telephone and cable television wires) to support cables. Lashing wire can be stainless steel (200, 300 or 400 series) wire with a final diameter of 0.038 to 0.045 inches. The lashing wire can have a soft core with abrasion and corrosion resistance on the surface. In another example, the wire can be coated with nickel (Ni) and/or copper (Cu) to prevent bio-fouling (e.g., for use in fish farming). The wire can have a 50 micrometers thick coating on a 2 to 2.5 millimeter diameter 304 stainless steel core wire substrate.

In an aspect, described herein are materials having spatial segregation of different metal compositions in different portions of the material (e.g., a core portion and a metallurgically bonded surface layer). The spatially segregated materials can have different properties than can be achieved with a monolithic metal. For example, the spatially segregated material can have any combination of electrical, magnetic, corrosion resistance, scratch resistance, anti-microbial, heat transfer, and mechanical properties. In some cases, anti-microbial properties can be achieved by adding copper, aluminum or silver to steel surfaces. In some cases, scratch resistance can be achieved on light weight and/or soft alloys by doping with aluminum, magnesium or titanium surfaces with tungsten or cobalt. The cost of the material can be reduced by eliminating some of the alloying elements that would otherwise be in the bulk of the material.

In some cases, the materials described herein are used in heat exchangers. The improved heat exchangers described herein can have improved corrosion resistance and thermal (heat transfer) properties by alloying copper and nickel onto steel surfaces.

In some cases, the materials described herein are used in motors or transformers. The improved motors and transformers described herein can have improved performance by enriching steel surfaces with silicon and/or cobalt.

In some cases, the materials described herein are used as catalysts. The improved catalysts described herein can have reduced costs by embedding catalytic particles in steel surfaces.

In an aspect, described herein are methods for producing metal materials comprising purchasing a metal substrate, forming a metallurgically bonded layer on the metal substrate, and selling the metal material comprising the metal substrate and the metallurgically bonded layer. In some cases, the method produces the metal material for lower cost than a metal material having the composition of the metallurgically bonded layer throughout the entire material.

### EXAMPLES

### Example 1

### Metallurgically Bonded Stainless Steel

A first example is a metallurgically bonded stainless steel on a steel form that includes a core region that comprises at least 55 wt. % iron and carries a stainless steel coating. The stainless steel coating consists of a stainless steel region and a bonding region. The stainless steel region has a thickness of about 1 μm to about 250 μm, and a stainless steel composition that is approximately consistent across the thickness of the stainless steel region. The stainless steel composition includes an admixture of iron and chromium, and includes a chromium concentration of about 10 wt. % to about 30 wt. %. The bonding region is positioned between the stainless steel region and the core region, has a thickness that is greater than 1 μm and less than the thickness of the stainless steel region, and has a bonding composition. The bonding composition includes an admixture of iron and chromium, and the bonding composition has a chromium concentration proximal to the stainless steel region that is approximately equal to the chromium concentration of the stainless steel region and has a chromium concentration proximal to the core region that has less than about 5 wt. % chromium.

### Example 2

### Metallurgically Bonded Stainless Steel with Two Bonding Regions

A second example is a steel sheet that includes a first stainless steel region having a thickness of about 1 μm to about 250 μm. A first bonding region positioned between the first stainless steel region and a core region has a thickness that is greater than 1 μm and less than the thickness of the first stainless steel region. A core region have a thickness of about 100 μm to about 4 mm and a core composition that comprises at least 85 wt. % iron. A second bonding region positioned between the core region and a second stainless steel region has a thickness of about 1 μm to about 250 μm. The second bonding region has a thickness that is greater than 1 μm and less than the thickness of the second stainless steel region. The first and second stainless steel regions have stainless steel compositions that are approximately consistent across the thickness of the respective stainless steel regions. Individually, the stainless steel compositions include an admixture of iron and chromium, and a chromium concentration of about 10 wt. % to about 30 wt. %. The first and second bonding regions have bonding compositions that, individually, comprise an admixture of iron and chromium, having a chromium concentration proximal to the stainless steel region that is approximately equal to the chromium concentration of the stainless steel region and having a chromium concentration proximal to the core region that has less than about 5 wt. % chromium.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives, modifications, variations or equivalents to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A material that comprises an alloyed metal layer having an alloying agent, the alloyed metal layer being coupled to a substrate with the aid of a diffusion layer between the alloyed metal layer and the substrate, wherein the amount of alloying agent in the diffusion layer changes with depth at a rate between about −0.01% per micrometer and −5.0% per micrometer as measured by x-ray photoelectron spectroscopy.

2. (canceled)

3. The material of claim 1, wherein the diffusion layer provides a metallurgical bond between the alloyed metal layer and the substrate.

4. The material of claim 1, wherein the alloyed metal layer comprises stainless steel.

5. The material of claim 1, wherein the alloying agent comprises chromium.

6. The material of claim 1, wherein the alloying agent comprises nickel.

7. The material of claim 1, wherein the alloying agent comprises iron.

8. The material of claim 1, wherein the substrate comprises a steel substrate.

9. (canceled)

10. The material of claim 8, wherein the substrate comprises carbon steel.

11. The material of claim 1, wherein the thickness of the alloyed metal layer is less than 200 micrometers.

12. (canceled)

13. (canceled)

14. The material of claim 1, wherein the depth is measured from an exterior surface of the alloyed metal layer.

15. (canceled)

16. The material of claim 1, wherein the alloyed metal layer has a composition that varies by about 20 wt. % or less over a depth of about 50 micrometers or less.

17. A material that comprises an outer metal layer metallurgically bonded to a steel substrate, wherein the material has a composition that varies by about 20 wt. % or less over a depth of about 50 micrometers or less and corrodes at a rate of at most about 1 nanometer per hour when exposed to an oxidizing or corrosive environment.

18. The material of claim 17, wherein the outer metal layer comprises steel.

19. The material of claim 17, wherein the outer metal layer comprises stainless steel.

20. The material of claim 17, wherein the outer metal layer comprises chromium.

21. The material of claim 17, wherein the outer metal layer comprises nickel.

22. (canceled)

23. The material of claim 17, wherein the steel substrate comprises carbon steel.

24. The material of claim 17, wherein the thickness of the outer metal layer is less than 200 micrometers.

25-28. (canceled)

29. The material of claim 17, wherein the surface of the material corrodes at a rate of at most 10 micrometers per year.

30. (canceled)

31. The material of claim 17, wherein the material has no material discontinuity between the outer metal layer and the steel substrate.

32. (canceled)

33. A material that comprises a stainless steel layer metallurgically bonded to a steel substrate, wherein the material has a composition that varies by about 20 wt. % or less over a depth of about 50 micrometers or less and has a corrosion resistance of at least about 1 year under the copper acetic acid spray (CASS) test.

34-39. (canceled)

40. A metal-containing object that comprises a steel core at least partially coated with an alloyed metal layer having an alloying agent, wherein the alloyed metal layer has a thickness of less than 500 micrometers, and wherein the concentration of the alloying agent is at a maximum concentration in the metal-containing object and decreases by no more than 20 wt. % in the alloyed metal layer over a depth of about 50 micrometers or less as measured with x-ray photoelectron spectroscopy.

41-53. (canceled)

54. A metal-containing object that comprises an alloying agent, wherein the alloying agent has a concentration of at least 10 wt. % at a depth of less than or equal to 30 micrometers from the surface of the metal-containing object, and wherein the alloying agent has a concentration of at most 6 wt. % at a depth of greater than 150 micrometers from the surface of the metal-containing object.

55-57. (canceled)

58. The metal-containing object of claim 54, wherein the alloying agent comprises chromium.

59. The metal-containing object of claim 54, wherein the alloying agent comprises nickel.

60. The metal-containing object of claim 54, wherein the alloying agent comprises iron.

61. The metal-containing object of claim 54, wherein the alloying agent has a concentration of at least 15 wt. % at a depth of less than or equal to 50 micrometers from the surface of the metal-containing object.

62. (canceled)

63. (canceled)

64. The metal-containing object of claim 54, wherein the metal-containing object is metal roofing material.
